(19) United States
(12) Patent Application Publication
(10) Pub. No.: US 2012/0278124 A1
(43) Pub. Date: Nov. 1, 2012

(54) METHODS AND SYSTEMS FOR OBTAINING AND PROCESSING INFORMATION FOR INTERRELATED PROCESSES

(76) Inventor: Albert Cecchini, Jamestown, NY (US)

(21) Appl. No.: 13/283,842

(22) Filed: Oct. 28, 2011

Related U.S. Application Data
(60) Provisional application No. 61/455,889, filed on Oct. 28, 2010.

(51) Int. Cl. G06Q 10/06

(52) U.S. Cl. 705/7.26

(57) ABSTRACT

A method creates and employs a process tier structure to determine changes to a process made up of interrelated processes. All stakeholders of the process are determined, each stakeholder having a set of associated characteristics and a set of associated processes. A process tier is then determined for each stakeholder based upon the set of associated characteristics and the set of associated processes of each stakeholder. A process tier structure is created based upon the determined tiers. The process tier structure provides information regarding interactions between the process stakeholders and the process tiers, as well as information regarding the interrelationships among the set of associated processes of the process stakeholders. The process tier structure may then be used to model the process, evaluate process modification requirements, implement determined modifications efficiently, and produce documentation or analysis of the process.

### CROSS-REFERENCE TO RELATED APPLICATIONS

This application is a non-provisional application that claims priority to U.S. Provisional Patent application No. 61/455,889 entitled “A System for Collecting and Processing Information for an Alliance of Organizations Providing Social Services to a Recipient Population” filed on Oct. 28, 2010, the teachings of which are incorporated by reference herein.

### FIELD OF THE INVENTION

Embodiments of the invention relate generally to the field of information processing and analysis and more specifically to methods of gathering and reviewing, organizing, and depicting information for multiple interrelated processes affecting interdependent stakeholders.

### BACKGROUND OF THE INVENTION

Many types of complex processes include multiple interrelated processes that involve complex and dynamic relationships between interdependent stakeholders. As an example, the process of providing social services to a recipient population comprises multiple interrelated processes among the various stakeholders. In such a process, the stakeholders would include, for example, a central governing organization, regional governing organizations, providers, and recipients of the services, all of which dynamically interact with one another. Analyzing and documenting these interactions often yield documentation which is beyond the ability of individuals to analyze efficiently and comprehensively. As a result, tasks which required the documentation such as staff training, work flow streamlining, and software system development can become labor intensive and perhaps unachievable.

Conventional processes often employ intricate and burdensome data collection and documentation processes that are not responsive to the specific requirements of the various process stakeholders. Likewise, conventional processes are often static and fail to respond to the changing requirements of the various process stakeholders, such as changing and increasing membership of one or more of the process stakeholders and evolving management and reporting requirements. Improved methods are desired for gathering and reviewing, organizing, and depicting information for multiple interrelated processes affecting such interdependent stakeholders.

### SUMMARY OF THE INVENTION

For one embodiment of the invention, a method is disclosed that creates and employs a process tier structure to determine changes to a process. For example, all stakeholders of a process are determined, each stakeholder having a set of associated characteristics and a set of associated processes. A process tier is then determined for each stakeholder based upon the set of associated characteristics and the set of associated processes of each stakeholder. A process tier structure is created based upon the determined tiers. The process tier structure provides information regarding interactions between the process stakeholders and the process tiers, as well as information regarding the interrelationships among the set of associated processes of the process stakeholders. The process tier structure may then be used to evaluate process modification requirements and to implement determined modifications efficiently. The process tier structure may be used to represent the modifications to the process. The process tier structure may be used to model or document the process, including creating papers or books that document the process. Moreover, information may be extracted from the process tier structure to produce an analysis of the process or an analysis of components or aspects of the process.

Other features and advantages of embodiments of the present invention will be apparent from the accompanying drawings, and from the detailed description, that follows below.

### BRIEF DESCRIPTION OF THE DRAWINGS

The foregoing summary, as well as the following detailed description of exemplary embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 illustrates the output from the methods as a process tier pyramid in accordance with one embodiment of the invention;

FIG. 2 illustrates a computer system which implements methods in accordance with embodiments of the invention.

FIG. 3 illustrates a computer system for modeling and implementing a method in accordance with one embodiment of the invention;

FIG. 4 illustrates an exemplary computing system implementing what was discovered and depicted as a process tier structure method in accordance with one embodiment of the invention; and

FIG. 5 illustrates a sequence diagram of a network that supports a process tier structure method within a software framework which models what was discovered in accordance with one embodiment of the invention.

### DETAILED DESCRIPTION OF ILLUSTRATIVE EMBODIMENTS

Overview:

A method is disclosed that creates and employs a process tier structure to determine changes to a process. For one embodiment, all stakeholders of a process are determined, each stakeholder having a set of associated characteristics and a set of associated processes. A process tier is then determined for each stakeholder based upon the set of associated characteristics and a set of associated processes of each stakeholder. A process tier structure is created based upon the determined tiers. The process tier structure is then used to evaluate process modification requirements and to implement determined modifications efficiently.

In the following description, numerous specific details are set forth. However, it is understood that embodiments of the invention may be practiced without these specific details. In other instances, well-known architectures, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

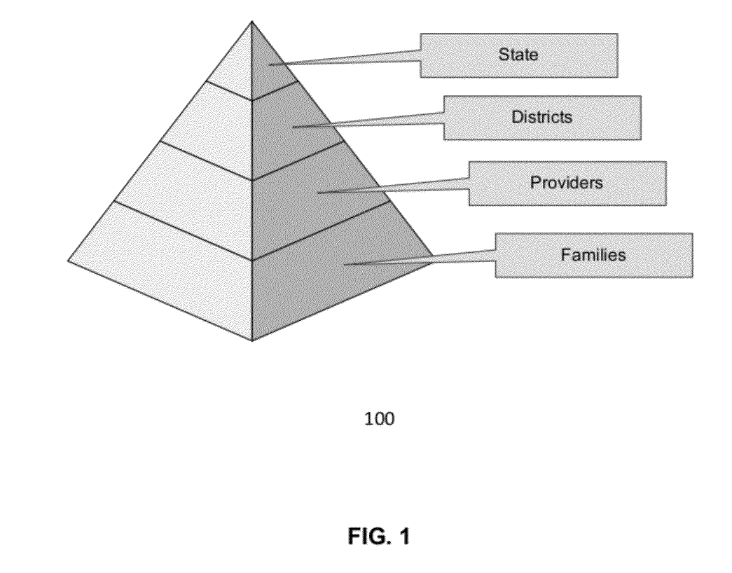

Embodiments of the invention are applicable in a variety of settings in which complex processes involving multiple interrelated processes affecting interdependent stakeholders, are employed and modified. In an exemplary embodiment, the method creates and uses various combinations and sequences of processes to create interrelated yet distinct process tiers. The process tiers define and document complex relationships and interactions between each process stakeholder and the processes associated with each process stakeholder. The process tiers form a process tier structure, which may be, for example, a process tier pyramid. FIG. 1 illustrates a process tier pyramid in accordance with one embodiment of the invention. In FIG. 1, the process tier pyramid 100 illustrates the output of the methods to group and describe the process of providing social services to a recipient population. Process tier pyramid 100 shows the process stakeholders as families, providers, districts, and state. Each process stakeholder has associated characteristics and associated processes.

Processes associated with each process stakeholder may generally include assessment, requirements, and documentation. These processes are used to create and arrange the process tiers into a process tier pyramid by grouping common sets of characteristics and requirements; positioning process stakeholders within the process tier pyramid by membership (e.g., the largest process stakeholder group on the bottom and the smallest process stakeholder group on the top), or by the role of the process stakeholder in the process.

The processes within each tier of the process tier pyramid are then defined. The interfaces between the tiers of the process tier pyramid are also defined. Such interfaces include the interaction between process stakeholders and the interrelationships among the processes associated with each process stake holder. The process tier pyramidal depiction may then be used to guide any follow-on work such as articles, books, diagrams, software automation, etc., thereby simplifying the description, needs, and requirements of even the most complex project.

Details documented by application of the exemplary methods include: the recipient population having the largest population interacting with the system per day requires an easy process for: applying for eligibility of a social service, such as childcare; clocking in and out of the service; scheduling the service; and insuring costs are quickly covered for the service. The service providers having the second largest population interacting with the system require an efficient process for: reducing paperwork; streamlining the process of providing services; and reducing the costs associated with administering the services. For example, administrative tools are employed for tracking and managing time and attendance, billing and payments, and reporting. The regional governing organizations with staff responsible for monitoring and managing the system across all providers require an easy process for: similar tasks of the provider tier, but from a regional perspective; providing eligibility determination assistance; and fulfilling reporting requirements of the central governing organization. The central governing organization that oversees the system and has a fiduciary responsibility for the welfare of the recipient population requires an efficient process for: supporting its fiduciary responsibilities; insuring funds get to the approved providers and members of the serviced population; and fulfilling reporting requirements for any supervising governing organization (e.g. a federal agency, other state agency, etc . . . ).

Gathering & Reviewing

In the quest to understand this dynamic and complicated environment of a state child payment system and to automate it using software, systems for information collection and processing catering to such large and diverse stakeholders have many technical challenges. Not only must the systems technically meet the aforementioned needs of the stakeholders, but the systems must adapt with the changes that will occur within each group of stakeholders. Technical challenges of the aforementioned system include: assuring the systems scales up to a potentially large population, such as a state population; assuring the system meets each stakeholders' management and reporting needs; eliminating the need for manual writing and transcribing; and providing a flexible foundation from which to grow and evolve. Such a flexible foundation must be able to: add and accept existing provider devices for checking in and out recipients, such as card swipes and biometrics (identification technologies used by largest providers); satisfy modifications to changing regulations, data elements, reporting tools, and management needs; enable creation of simple systems, so training is minimal for the majority of the stakeholders using the system, especially the recipient population and providers; integrate with providers' existing systems; interface and/or replace existing systems of regional governing organizations; and meet the change management challenges that will arise out of the technical challenges.

For one embodiment of the invention, an operation of the method gathers the information and reviews it for similar characteristics and traits. For example, in a child payment system characteristics such as member roles (e.g. children, parents, day care workers, agency overseers, etc.), child age, stakeholder job description, time, cost, reports, policies, rules, important data elements, entity diagrams, process flow diagrams, existing methods for recording data, political atmosphere, role, role interactions, and the like are determined. Information is then reviewed and tagged with one or more tags corresponding to the associated characteristics. This step is completed when all of the gathered information is gathered and reviewed.

Organization:

For one embodiment of the invention, an operation of the method determines stakeholders of a process based upon a common set of characteristics and needs. For example, stakeholders involved in a state Child Payment System (CPS) can be grouped into four generalized tiers. The tiers for such a process may include families who take their children to day care centers, day care center staff, county agency staff, and state staff.

Another operation of the method, for one embodiment of the invention, determines a process tier for each stakeholder and may position each stakeholder within a process tier structure based upon the size of the stakeholder (i.e., number of persons comprising the stakeholder). For example, the process tier pyramid 100 of FIG. 1 positions the stakeholders in tiers according to size, with the largest group, families, on the bottom and the smallest group, state staff, on the top.

Additionally, or alternatively, an operation of the method may determine a process tier for each stakeholder and may position each stakeholder within a process tier structure based upon one or more other characteristics of the stakeholders. For example, the role of each stakeholder may be used to position each stakeholder within a process tier structure. In the context of a process by which multiple stakeholders receive or provide social services, as shown in FIG. 1, the roles of each stakeholder may include: parents dropping off and picking up children and insuring their well-being, day care staff overseeing the care of the children and the eligibility for supplemental funding of the family, county staff overseeing the licensing of the day care centers, the available funding, and child safety, state staff overseeing county staff performing their monitoring tasks, allocating funding, and overseeing the state's program.

In a further operation of the method for one embodiment of the invention, a process tier structure is created based upon defined processes within each of the determined process tiers and defines the interfaces between tiers. For example, in the context of a process by which multiple stakeholders receive or provide social services related to a child payment system, the processes for each tier may be as follows. The processes for families may include scheduling and documenting the drop off and pick up their children, designating authorized contact personnel (e.g. designating who is allowed to visit and pick up their children), and paying outstanding bills. The processes for day care workers may include billing, dunning, class schedules and activities. The processes for county may include reporting, site visits, budgeting, and conducting child welfare reviews of incident reports. The processes for state staff may include overseeing county staff activities, budgeting funds to the county level, running state level reports, and monitoring operation of state wide services.

In a further operation of the method for one embodiment of the invention, the process tier structure may also define the interfaces among the tiers of the process tier structure as the process interactions between the tiers. For example, in the context of a process by which multiple stakeholders receive or provide social services, such interrelated processes may include families scheduling day care services with the day care provider, or may include families applying for funding for day care. The processes may also include day care staff billing families based on the dates and times of the schedule and determining family eligibility for financial support. The day care staffs regularly report up to the county staff the numbers of families served and the amount of monies used in supporting the families. Other interrelated processes may include the county staff receiving enrollment numbers from the day care staff, determining the number of children served throughout the county, and providing the information to the state staff. The state staff may effect similar processes to determine the number of children served throughout the state.

Depicting:

As discussed above, an embodiment of the invention is applicable to a process by which social services are provided to a recipient population, such as a state population. For such a process, there are a number of stakeholders where each stakeholder is interdependent with other stakeholders. Typically, the stakeholders include a central governing organization, regional governing organizations, providers, and recipients of the services. Upon applying the methods, these stakeholders and their interdependencies can be depicted in the process tier pyramid of FIG. 1. As discovered and organized through the use of the methods, the process tier pyramid 100 illustrates that each tier relies on the tier below it for support and the tier above it for guidance and supervision. The process tier pyramid 100 further illustrates the respective importance of the recipient population and their providers in supporting the other tiers; the respective importance of the central and regional governing organizations in overseeing the lower tiers. In this example, dissemination of program information is from the top down; data flow is from bottom up; and money and resources flowing from the top down.

In a further operation of the method for one embodiment of the invention, the completed process tier structure may be used to modify and improve the processes for the various stakeholders and thereby improve the overall process (e.g., a process by which multiple stakeholders receive or provide social services). For example, if the parents use a card swipe instead of paper to record when they drop off and pick up their children, how does this effect the processes within their tier and between tiers.

In a further operation of the method for one embodiment of the invention, the completed process tier structure may be used to provide the documentation requirements of the process stakeholders and readily and efficiently adapts its representations to modifications of process stakeholder characteristics. For example, the method may take into account documenting existing provider devices for checking in and out recipients, such as card swipes and biometrics (identification technologies used by the largest providers) or, for example, accommodating modifications to changing regulations, data elements, reporting tools, and management needs. Embodiments of the invention provide a method that enables generation of: documentation such as the interactions within and between tiers based on the organized characteristics, scientific papers from the discoveries within the intricate relationships, books concerning pros and cons of the processes depicted, software systems, stakeholder change management, efficient training and related documentation of the process stakeholders in using the method.

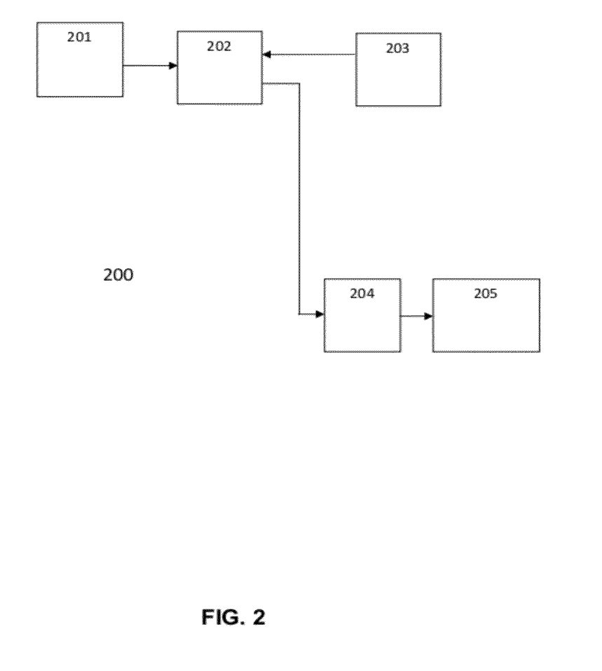

FIG. 2 illustrates a computer system which implements s methods in accordance with embodiments of the invention. These methods may be embodied in software to include an information system hosted by one or more computer systems of a computer network that facilitates collecting, characterizing, and storing information collected and reviewed; automation of the processing and organizing of the collected and reviewed information related to the tiers; and generating and labeling the graphic representation of the tiered structure. System 200, shown in FIG. 2, includes a storage arrangement 201 for storing information regarding the process and the process stakeholders. Such information may include characteristics for each stakeholder. Organization application 202 organizes the stored information based upon common the characteristics and processes of the stakeholders as discussed above in reference to FIG. 1. The organization application 202, may, for example, determine a tier for each stakeholder based upon common characteristics and processes. The process tier structure application 203 creates a process tier structure based upon the tiers. A graphics engine 204 graphically depicts the process tier structure which may be viewed by a system user via a user interface 205.

As suggested above, the software based embodiment may store the information derived from the analysis processes of the method. An embodiment of the invention includes the methods whereby the software stores business rules, thresholds, and regulatory values from the analyzed processes and stakeholders that are then stored and administered through database tables by appropriate end-users. Appropriate end-users may be determined by permission settings of the tables. For such an embodiment, the business rules, thresholds, and regulatory values, are stored in a data structure, such as a database table, rather than coded into a software component. The business rules, security, thresholds, and regulatory values embodied within the table follow guidelines that may typically be prescribed by state regulations and agency guideline. Such an embodiment can allow the stakeholders to directly contribute to the documentation process of the methods.

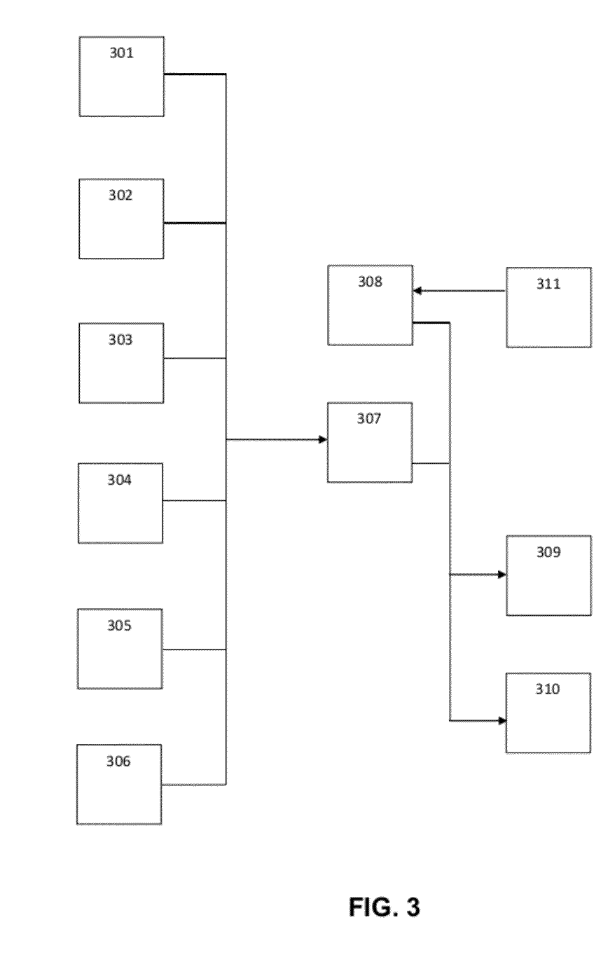

FIG. 3 illustrates a computer system for modeling methods in accordance with embodiments of the invention. Characterizations and depictions of these methods may be embodied in software to include an information system hosted by one or more computer systems of a computer network which automates the processes discovered through the use of the methods. Systems such as these facilitate collecting, processing, and storing information related to the tiers. For example, the information and depiction may include an eligibility determination form 301, a family/individual composition form (i.e. family composition form) 302, a scheduling and calendaring form 303, a time and attendance form 304, a state agency, regional agencies, providers, and recipients of the social services 305, and transactions between the state agency, the regional agencies, the providers, and the recipients 306. Additionally, such a network of computer systems facilitates communications of such information inside and external to the network of computer systems. Such communications include communicating such information to an input arrangement 311; communicating to middleware, information stored in an information storage arrangement 307 and information communicated from the input arrangement 308; and communicating from the middleware, information stored in the information storage arrangement 309 and information to an output arrangement 310.

Embodiments of the invention include methods whereby software facilitates the information systems. In one embodiment, the software is based off a software framework; and in such an embodiment, the input arrangement and the output arrangement may include at least one web form that is compatible across multiple Internet browsers. In another embodiment, input/output is facilitated via a telephony solution. In either of the embodiments, the information storage arrangement possibly includes a social service management software schema and at least one database table that includes table-driven business rules within a tier relating to eligibility determination, family composition, scheduling and calendaring, time and attendance; and between the tiers including the state agency, the regional agencies, the providers, the recipients, and the transactions between such stakeholders.

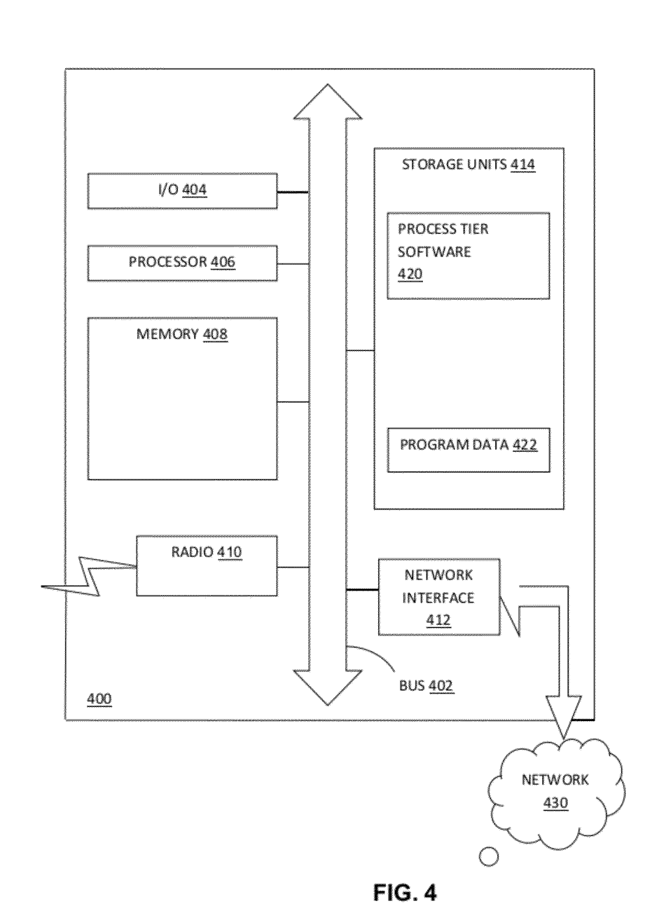

Embodiments of the invention may be implemented using typical computer systems or any type of digital processing system. FIG. 4 illustrates an exemplary computing system implementing a process tier structure method in accordance with one embodiment of the invention. The computer 400 includes a processor 406 in communication with a computer readable storage medium, where the computer readable storage medium is any medium that that stores information for retrieval later by the processor 406. Computer readable storage medium includes memory 408 and data storage units 414. Memory 408 is possibly a fast-access memory and is used to run program instructions executable by the processor 406. Memory 408 is also possibly random access memory (RAM), read only memory (ROM), and/or flash memory. Data storage units 414 are possibly physical devices and are used to store any data and instructions which may be accessed by the processor 406, such as program data 422 and instructions for the software that facilitates an embodiment of a process tier software 420. Data storage units 414 are possibly an optical medium, a magnetic medium such as a floppy disk, a compact disc (CD), a digital video disk (DVD), and/or a solid-state medium such as RAM, ROM, and flash memory.

The computer 400 operates in a networked environment using logical connections to communicate with other computers and communication devices. The computer 400 and other computers and communication devices are possibly a personal computer, a server, a router, a network PC, a peer device, or other types of network nodes. When used in a LAN or WLAN networking environment, the computer 400 is connected to other computers and communication devices via the LAN or WLAN through a network interface 412. The computer 400 also includes a radio 410 for wirelessly transmitting and receiving data.

To provide input/output to and from the elements of the computer system, the computer 400 has input/output devices 404, a bus 402, and other circuitry that facilitates coupling between the input/out devices 404 and other elements of the computer system.

The above-mentioned software and electrical components of the computer system are made of computer hardware, software, firmware, or any combination thereof. The communications between such software and electrical components occur in the form of signals including electronic signals, electromagnetic signals, optical signals, or any combination thereof.

Where software is used to implement the process tier structure method, platforms or frameworks such as .NET, J2EE, open source technologies, or any combination thereof may be used. While elements of the process tier structure method are illustrated using .NET technologies; however, comparative technologies may substitute or combine with the .NET technologies. For example, JSP or PHP are alternative technologies to ASP.NET where the method is implemented using J2EE or open source technologies. Where a software framework is used, software framework components may include: a common data access interface; a data access tier, which allows simultaneous access to multiple databases and database platforms (e.g. ADO.NET, ODBC, etc . . . ); a data merge (e.g. data merge using XML); an interpreter tier (e.g. an interface using XML); a user interface creation tier; and a presentation tier including at least one thin client.

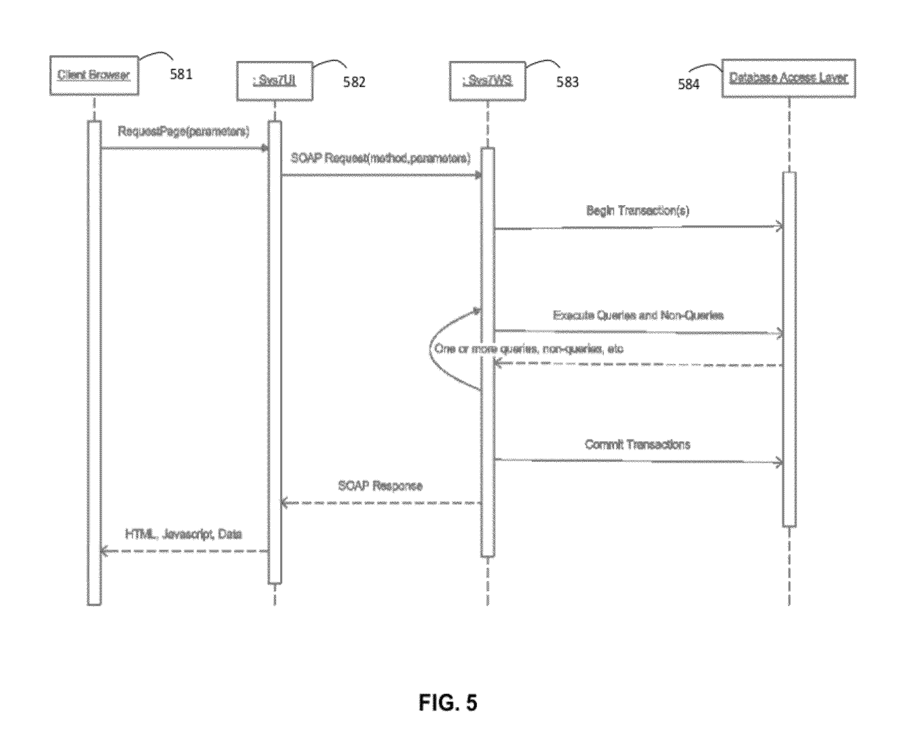

FIG. 5 illustrates a sequence diagram of a network that supports a process tier structure method within a software framework in accordance with one embodiment of the invention. For example, a network may support a process tier structure method by which multiple stakeholders provide social services to a recipient population. The diagram includes a client browser 581, a user interface application 582, a web services application 583, and a database access layer 584. First, the client browser 581 makes a page request to the user interface (UI) application 582. Next, the UI application 582 makes a SOAP request to the web services (WS) application 583, calling a method of the WS application 583 with parameters. The method of the WS application begins a transaction(s) with the database access layer 584, executes queries and non-queries, and then the database access layer after communicating with a database returns data to the WS application. Then, the data is checked by the WS application 583 and then the transactions are committed. Finally, the WS application 583 sends a SOAP response to the UI application 582 that in turn sends HTML, JavaScript, and data to the client browser 581 that renders a view to the end-user.

Embodiments of the invention have been described as including various operations. Many of the processes are described in their most basic form, but operations can be added to or deleted from any of the processes without departing from the scope of the invention. For example, for various alternative embodiments, the process tier structure method and software have been described in the context of a process by which social services are provided to a recipient population, which has specific data and information flow and specific interdependencies between stakeholders. However, embodiments of the invention are applicable to a wide range of situations in which complex processes involving multiple interrelated processes affecting interdependent stakeholders, are employed and modified. Thus alternative embodiments of the invention, applied to various processes may include additional or different operations than those discussed in reference to a process providing social services.

The operations of the invention may be performed in paper, by hardware components, or may be embodied in machine-executable instructions, which may be used to cause a general-purpose or special-purpose processor or logic circuits programmed with the instructions to perform the operations. Alternatively, the steps may be performed by a combination of paper, hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central site or, alternatively, one or more operations may be performed elsewhere.

Though various embodiments of the present invention have been described above, it should be understood that embodiments have been presented by way of example, and not limitation. A person of ordinary skill in the art will recognize that there are various changes that can be made to the present invention without departing from the spirit and scope of the present invention. Therefore, the invention should not be limited by any of the above-described example embodiments, but should be defined only in accordance with the following claims and equivalents of the claimed invention.

What is claimed:

1. A method comprising:
determining a plurality of stakeholders of a process, each stakeholder having a set of associated characteristics and a set of associated processes;
determining a process tier for each stakeholder based upon the set of associated characteristics and the set of associated processes; and
creating a process tier structure to depict the process, the process tier structure based upon the determined process tiers, the process tier structure providing information regarding an interaction between each of the plurality of process stakeholders and each of the plurality of process tiers, the process tier structure based upon and depicting information regarding the interrelationships among the set of associated processes of each of the plurality of process stakeholders.

2. The method of claim 1 wherein one or more of the steps of determining a plurality of stakeholders of a process, determining a process tier for each stakeholder, and creating a process tier structure to depict the process is implemented using a digital processing system.

3. The method of claim 1 wherein the process tier structure is used to model the process.

4. The method of claim 3 wherein modeling the process includes creating a documentation of the process, providing means for analyzing the process, and creating a software application for effecting the process.

5. The method of claim 1, wherein the process tier structure is used to determine affects of one or more modifications to the interrelated processes.

6. The method of claim 1, wherein the process tier structure is used to determine an approach to modifying the interrelated processes.

7. The method of claim 1, wherein the interrelated processes provide social services to a recipient population.

8. The method of claim 7, wherein the stakeholders of the process include receivers of social services, providers of social services, local oversight agency, and state oversight agency.

9. A machine-readable medium having stored thereon instructions which when executed by a machine, cause the machine to perform a method, the method comprising:
determining a plurality of stakeholders of a process, each stakeholder having a set of associated characteristics and a set of associated processes;
determining a process tier for each stakeholder based upon the set of associated characteristics and the set of associated processes; and
creating a process tier structure to depict the process, the process tier structure based upon the determined process tiers, the process tier structure providing information regarding an interaction between each of the plurality of process stakeholders and each of the plurality of process tiers, the process tier structure based upon and depicting information regarding the interrelationships among the set of associated processes of each of the plurality of process stakeholders.

10. The machine-readable medium of claim 9 wherein the process tier structure is used to model the process.

11. The machine-readable medium of claim 10 wherein modeling the process includes creating a documentation of the process, providing means for analyzing the process, and creating a software application for effecting the process

12. The machine-readable medium of claim 9, wherein the process tier structure is used to determine affects of one or more modifications to the interrelated processes.

13. The machine-readable medium of claim 9, wherein the process tier structure is used to determine an approach to modifying the interrelated processes.

14. The machine-readable medium of claim 9, wherein the interrelated processes provide social services to a recipient population.

15. The machine-readable medium of claim 14, wherein the stakeholders of the process include receivers of social services, providers of social services, local oversight agency, and regional oversight agency.
